(19) United States
(12) Patent Application Publication
(10) Pub. No.: US 2025/0258793 A1
(43) Pub. Date: Aug. 14, 2025

(54) METHOD FOR EXCHANGING INTERFACE INFORMATION REGARDING A PCI EXPRESS INTERFACE

(71) Applicant: Robert Bosch GmbH, Stuttgart (DE)

(72) Inventor: Sebastian Reinemuth, Zeiskam (DE)

(21) Appl. No.: 19/047,859

(22) Filed: Feb. 7, 2025

(30) Foreign Application Priority Data
Feb. 13, 2024 (DE) 10 2024 201 286.6

(51) Int. Cl. G06F 13/42

(52) U.S. Cl. CPC G06F 13/4282; G06F 2213/0026

(57) ABSTRACT

A method for exchanging interface information between different communication partners for the communication of the communication partners via PCI Express. The method includes: a) ascertaining an interface definition, which describes memory areas and an internal memory layout of a first communication partner which a second communication partner is to access to read and/or write data; b) creating a serialized form of the interface definition ascertained in step a); c) providing the serialized form of the interface definition created in step b) to the second communication partner; and d) automatically configuring the second communication partner with the transmitted interface definition for the communication between the communication partners.

### CROSS REFERENCE

The present application claims the benefit under 35 U.S.C. § 119 of German Patent Application No. DE 10 2024 201 286.6 filed on Feb. 13, 2024, which is expressly incorporated herein by reference in its entirety.

### BACKGROUND INFORMATION

PCIe or PCI Express is a point-to-point bus system, which makes communication between individual data processing units of a hardware system possible, for example between a peripheral device and a main processor. PCI Express makes very high data transfer speeds possible.

The data processing units that communicate with one another via a PCI Express bus are also referred to as communication partners.

An important feature of PCI Express is that it makes possible direct access to the (internal) memory of the communication partner with whom communication is taking place via PCI Express. In particular, the processor (CPU) of the communication partner with whom communication is taking place is not involved in the communication. One (data-transmitting) communication partner writes the data directly into the memory of the other (data-receiving) communication partner, without the processor of the other communication partner being involved. This makes high communication speeds possible, in particular because the speed of communication is not limited by the capacity of the processors of the data-receiving communication partner and of the data-transmitting communication partner. In particular, the data-transmitting communication partner does not have to route the data through a communication stack first and does not have to split, package and transmit data for this purpose. This usually requires processor resources, which can be saved when using PCI Express for communication between the communication partners.

In order for such communication to be possible, the memory management of the corresponding communication partners must be known to one another. The communication partner must know exactly to/from which areas of the memory of the other communication partner it should and may write/read.

This requirement of PCI Express presents a significant challenge, in particular when developing complex systems comprising hardware and software with a plurality of involved data processing units that communicate via PCI Express, and in the case of complex dependencies between the individual data processing units.

Such systems include, for example, systems for highly automated or autonomous driving operation of motor vehicles. Such systems are used, for example, to process sensor data obtained from sensors of the motor vehicle in order to acquire information for the highly automated or autonomous driving operation of the motor vehicle. Such systems regularly comprise a plurality of data processing units, which perform interdependent data processing tasks so that efficient communication between the individual data processing units is required in each case.

Communication between the data processing units in such systems regularly takes place via PCI Express.

Further systems for which the use of PCI Express for communication between data processing units poses significant challenges, in particular during development, are measurement systems that record data in order to use them later for experiments or as training data for machine learning.

Usually, communication between data processing units via PCI Express requires each data processing unit to have a configuration with which the memory areas and/or the memory structure of the communication partners is communicated to one another in advance. The (local and remote) memory areas/memory structures are configured within drivers of the corresponding communication partners. The term “local” refers here to resources (e.g., memories) of the corresponding communication partner itself. The term “remote” refers here to resources (e.g., memories) of the other (distant) communication partner. The first communication partner thus knows which memory locations of the second communication partner it may access (by reading and writing) so that they can interpret the data correctly. The data in the memory of the remote communication partner is accessed by the hardware of the local communication partner according to the configuration as specified by a driver.

During the development of such systems, the development work on the individual data processing units regularly also requires changes to interfaces to other data processing units and, in particular, adaptations of the memory layout and the memory allocation. This adaptation is usually carried out by providing adapted configuration files in which the interfaces are described. During the development of complex systems with many data processing units, such adapted configuration files must regularly be exchanged manually between development teams of the different data processing units. These files are then used to configure the corresponding drivers of the communication partners. The use of PCI Express as a communication interface between the data processing units then regularly also makes it necessary for even small adaptations of a data processing unit to require the exchange of new configurations between the individual data processing units or between the development teams that develop individual data processing units. This makes the process of developing such systems extremely complex and time-consuming.

### SUMMARY

The present invention provides a method for adapting PCI Express interfaces for communication between different data processing units or communication partners is proposed here, which significantly reduces the described complexity in the development process.

According to an example embodiment of the present invention, a method is provided for exchanging interface information between different communication partners for the communication between the communication partners via PCI Express, comprising the following steps:
a) ascertaining an interface definition, which describes memory areas and an internal memory layout of a first communication partner which a second communication partner is to access to read and/or write data;
b) creating a serialized form of the interface definition ascertained in step a);
c) providing the serialized form of the interface definition created in step b) to the second communication partner; and
d) automatically configuring the second communication partner with the provided interface definition for the communication between the communication partners.

A method for communication between a first communication partner and a second communication partner is provided according to the present invention. This method can be applied to both communication partners. Likewise, both communication partners can read from or write to the corresponding memory areas. In preferred design variants of the present invention, both communication partners are data processing units, which interact in a (larger) data processing system. Such data processing units can also interact and communicate with one another in both directions in a (larger) data processing system so that a data processing unit is at times used as the first communication partner and at times as the second communication partner. In each case, the second communication partner actively accesses (by reading and/or writing) the memory of the first communication partner.

PCI Express provides for direct access to the memory of a communication partner. This applies to both read and write access. According to an example embodiment of the present invention, the processor (or CPU/DMA) of the second communication partner directly accesses a memory of the first communication partner. For the memory area, provided for this purpose, of the first communication partner, addresses that are mapped to the memory of the first communication partner are provided in the local address space of the second communication partner.

When the second communication partner writes/reads data to/from these addresses in its local address space, these data are automatically written/read to/from the memory of the first communication partner.

This automatic transfer of data to/from the memory of the first communication partner takes place via PCI Express. The processor of the first communication partner is not involved in the transfer. The processor of the second communication partner accessing the provided local addresses in its address space automatically triggers the data transfer.

In this respect, PCI Express preferably maps the first three layers of the ISO/OSI reference model, namely the physical layer, the data link layer, and the so-called transaction layer. Above these three layers, custom programming is usually required to set up a PCI Express interface. The link between the addresses in the local address space of the second communication partner and the corresponding addresses in the memory of the first communication partner must be set up individually in the local driver when configuring a PCI Express interface.

According to an example embodiment of the present invention, it is now provided to automate the configuration of PCI Express interfaces, at least at times. For this purpose, it is proposed to provide an interface description, which describes the memory areas provided for accessing data as well as a memory layout of a first communication partner, in an interface definition, wherein the interface definition is provided in serialized form (steps a) and b)). Ascertaining the interface definition according to step a) can, for example, comprise reading out an object structure of the interface, which describes the memory areas and the memory layout provided for the communication with the second communication partner. The serialized form can be achieved according to step b), for example, by means of a function for serializing objects that is available in common programming languages.

The interface definition in serialized form can then be provided (step c)). With the interface definition, at least one communication partner is then automatically configured according to step d).

It is thus provided to provide the interface description or the interface definition in the form of a serialized information object. This makes it possible for a connected PCI Express device (the second communication partner) to dynamically connect to the interface of the first communication partner without knowing the exact PCIe protocol interface of the first communication partner.

The method of the present invention described here proposes a new approach to make the memory layout, provided for the communication via PCI Express, of a first communication partner known to another (second) communication partner.

It is particularly preferred if the interface definition ascertained in step a) also includes protocol information.

In particular, the interface definition ascertained in step a) includes information about registers and/or virtual registers to be described and their structures.

Protocol information or protocol register structures include in particular information on how protocol data relating to the communication carried out via a PCI Express interface should be stored and evaluated in order to ensure error-free communication via the PCI Express interface.

Providing the memory description in a serialized structure makes it possible to transmit the memory description according to step c) particularly efficiently. Besides the memory layout, additional information can be efficiently transmitted in a definition in the serialized interface description. This includes in particular protocol information.

With the help of the interface definition, second communication partners can automatically be adapted dynamically.

According to an example embodiment of the present invention, it is preferred if providing the interface definition according to step c) comprises storing the interface definition in serialized form in a memory area, provided for this purpose, of the first communication partner, wherein second communication partners retrieve the interface definition from the memory area of the first communication partner.

According to an example embodiment of the present invention, in systems in which changes to individual data processing units are made regularly, the communication between these data processing units is often complex to implement. There is often the problem of a “hard” dependence on information. For example, the memory layout and its use must be known in advance to both data processing units that are to communicate with one another as communication partners.

In order to solve this problem, it is provided according to the present invention to provide the memory definition and its use as a serialized object in an accessible memory of the first communication partner. The first communication partner then uses this interface definition to communicate in what form the second communication partner (other data processing units) is to access data in its memory.

According to an example embodiment of the present invention, it is preferred if the interface definition is first created according to step a) as an XML structure or JSON structure and then serialized according to step b) with a serialization function for XML or JSON.

XML and/or JSON are particularly suitable for describing complex structures. In addition to the memory layout, additional information, such as the protocol information described above, can be provided in a data structure, in particular with XML and/or JSON.

The second communication partner can preferably read the interface definition and adjust its system during “development” or at runtime to the used memory layout of the first communication partner.

Preferably, according to an example embodiment of the present invention, the second communication partner has a configurable communication stack for the communication with the first communication partner, wherein this configurable communication stack is configured in step d) with the transmitted interface definition.

According to an example embodiment of the present invention, the configurable communication stack forms a kind of configurable driver for the second communication partner, which is configured with the interface definition provided by the first communication partner in order to make smooth communication between the communication partners possible and, in particular, to avoid exchanging interface definitions between the communication partners manually when changes occur in the memory structure relevant for the communication between the communication partners.

According to an example embodiment of the present invention, the configurable communication stack or configurable driver is preferably set up to configure itself with the interface definition provided in step c). Particularly preferably, the interface definition is first deserialized for this purpose. The configurable communication stack or the configurable driver is preferably set up to then adapt to the data-receiving communication partner according to the interface definition.

According to an example embodiment of the present invention, it is particularly preferred if the method is used during the development of data processing units for the data processing of sensor data for highly automated driving.

Data processing units which act in particular as second communication partners in the described method are, for example, sensors or sensor systems which provide sensor data to further data processing units, which act in particular as first communication partners in the described method.

In particular during the development of such systems, developers often implement changes to data processing units which also affect the memory layout. Without the described method, it is regularly necessary to manually configure drivers on all further data processing units communicating with a data processing unit. This regularly involves a lot of time and effort, which greatly complicates the development of such systems. Through the method described, this time and effort can be largely eliminated or replaced by automation.

Also to be described here is a system for data processing is provided according the present invention. According to an example embodiment of the present invention, the system includes at least two data processing units, wherein at least one data processing unit as a second communication partner and at least one further data processing unit as a first communication partner are set up to exchange interface information with one another according to a method according to the present invention disclosed herein.

The present invention and the technical environment of the present invention are explained in more detail below with reference to the figures. The figures show preferred exemplary embodiments, to which the present invention is not limited. It should be noted, in particular, that the figures and in particular the size proportions shown in the figures are only schematic.

### BRIEF DESCRIPTION OF THE DRAWINGS

FIG. 1 shows a system comprising two data processing units, which are set up to exchange interface information with each other according to a method according to an example embodiment of the presnt invention.

FIG. 2 shows a flowchart of the disclosed method according to an example embodiment of the present invention.

### DETAILED DESCRIPTION OF EXAMPLE EMBODIMENTS

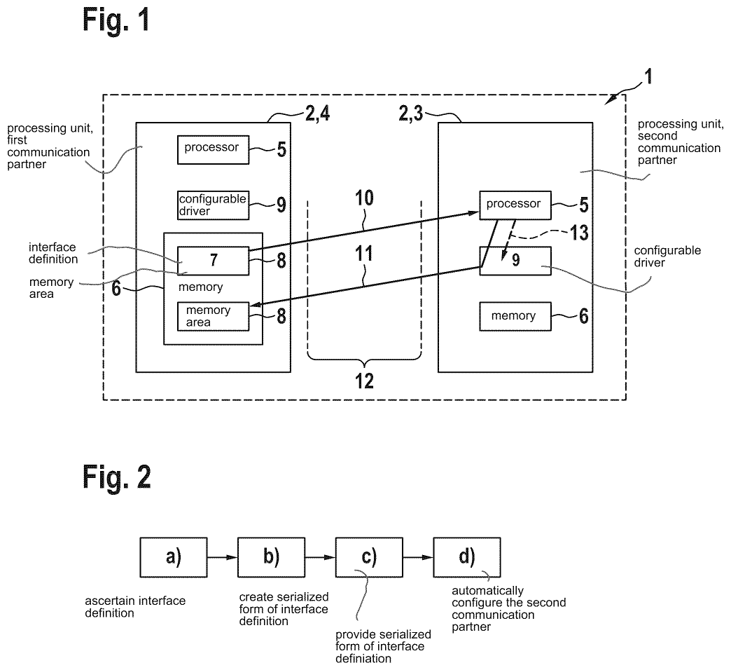

FIG. 1 shows a system 1 comprising two data processing units 2, which can exchange interface information with each other according to the method described here. One of the data processing units 2 is a second communication partner 3. Another of the data processing units 2 is a first communication partner 4. Both data processing units 2 preferably each have a processor 5 or a CPU and a memory 6. The communication between the two data processing units 2 preferably takes place via a PCI Express interface.

Preferably, the data processing unit 2 used as the first communication partner 4 provides the interface definition 7 in a memory area 8, provided for this purpose, of its memory 6. Preferably, the data processing unit 2 used as the second communication partner 3 retrieves this interface definition 7 from this memory area 8. This is shown schematically here by the interface transmission 10. Particularly preferably, a processor 5 of the data processing unit 2 used as the second communication partner 3 is set up to configure a configurable communication stack or a configurable driver 9 with the interface definition 7. This configuration 13 is shown as an arrow. The configuration 13 is carried out with the interface definition 7 so that a data transmission 11 via the PCI Express interface 12 is subsequently carried out in such a way that the data are correctly stored in the corresponding memory areas 8 provided for this purpose in the memory 6 of the data processing module 2 used as the first communication partner 4 (write access) or the desired data are correctly retrieved from the memory areas 8 provided for this purpose in the memory 6 of the first communication partner 4 (read access). The arrow for the data transmission 11 thus represents read access and write access that are carried out using the communication stack or the configurable driver 9 and their configuration according to interface definition 7.

FIG. 2 schematically shows a flowchart of the described method. The method steps a), b), c) and d) can be seen, which are carried out according to the described method in order to exchange interface information between communication partners which communicate with one another via a PCI Express interface.

What is claimed is:

1. A method for exchanging interface information between different communication partners for communication of the communication partners via PCI Express, the method comprising the following steps:
a) ascertaining an interface definition, which describes memory areas and an internal memory layout of a first communication partner which a second communication partner is to access to read and/or write data;
b) creating a serialized form of the interface definition ascertained in step a);
c) providing the serialized form of the interface definition created in step b) to the second communication partner; and
d) automatically configuring the second communication partner with the provided interface definition for the communication between the communication partners.

2. The method according to claim 1, wherein the interface definition ascertained in step a) also includes protocol information.

3. The method according to claim 1, wherein the transmitting of the interface definition according to step c) includes storing the interface definition in serialized form in a memory area provided for the purpose of storing the interface definition, of the first communication partner, wherein second communication partners retrieve the interface definition from the memory area of the first communication partner.

4. The method according to claim 1, wherein the interface definition is first created according to step a) as an XML structure or JSON structure and then serialized according to step b) with a serialization function for XML or JSON.

5. The method according to claim 1, wherein the second communication partner has a configurable communication stack for the communication with the first communication partner, wherein the configurable communication stack is configured in step d) with the provided interface definition.

6. The method according to claim 1, wherein the method is used during development of data processing units for data processing of sensor data for highly automated driving.

7. A system for data processing, comprising:
at least two data processing units, wherein at least one data processing unit of the at least two data processing units is a second communication partner, and at least one further data processing unit of the at least two data processing units is a first communication partner, and are set up to exchange interface information with one another for communication via PCI Express by:
a) ascertaining an interface definition, which describes memory areas and an internal memory layout of the first communication partner which the second communication partner is to access to read and/or write data;
b) creating a serialized form of the interface definition ascertained in step a);
c) providing the serialized form of the interface definition created in step b) to the second communication partner; and
d) automatically configuring the second communication partner with the provided interface definition for the communication between the communication partners.
